(19) United States
(12) Patent Application Publication
(10) Pub. No.: US 2005/0248552 A1
(43) Pub. Date: Nov. 10, 2005

(54) Calculator with a color changing display

(76) Inventor: Joyce Yu, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/841,451

(22) Filed: May 10, 2004

(51) Int. Cl. G09G 3/12

(52) U.S. Cl. 345/204

(57) ABSTRACT

A calculator with a color changing display, comprising mainly a keyboard, a CPU which is connected with said keyboard, an oscillator which is connected with said CPU, a LCD, a LED driver and a set of LED; by pressing the different key on the keyboard, the CPU would be driven to operate different calculations, and the CPU would receive the signal transmitted from the oscillator, then said LED would be driven to randomly display light of different colors.

### BACKGROUND OF THE INVENTION

1. Field of the Invention

The present invention relates to a calculator and more particularly to a calculator which is able to change the color of display when people is operating.

2. Description of the Prior Art

The calculator has been played an important role in people's life for a very long time. As shown in FIG. 1, the conventional calculator comprises a keyboard 100 and a liquid crystal display (LCD) 200. The keyboard includes a plurality of keys 101, 102, 103 . . . for people to press and drive the circuit inside the housing to operate, and then, show the result of operation on the LCD 200.

Said conventional calculator has the disadvantages as follows:
1. For the user, he only to press keys and read numbers on the LCD, the action is very simple and easy to be bored with.
2. Because the action is very simple and easy to be bored with, the value of product becomes lower than before.

### SUMMARY OF THE INVENTION

According, the object of the present invention is to provide a calculator having improved functions which have never been seen in a common calculator.

It is another object of the present invention to show not only a number corresponding to the result of calculation, but also different colors such that people will immediately be caught by its variable and interesting forms.

It is still another object of the present invention to keep the functions of a calculator; the value of calculator then is increased.

It is one more object of the present invention to use microcontroller IC and programming for microprocessing. Such that calculator of present invention can be made in small size with multiple functions and which is convenient for people's utilization.

### BRIEF DESCRIPTION OF THE DRAWINGS

FIG. 1 illustrates an embodiment of conventional calculator.

FIG. 2 is a block diagram showing the operation circuit of the present invention. FIG. 3 shows an embodiment of the practical circuit of this invention.

### DETAILED DESCRIPTION OF THE PREFERRED EMBODIMENTS

A preferred embodiment of this invention is described below in detail referring to the drawings.

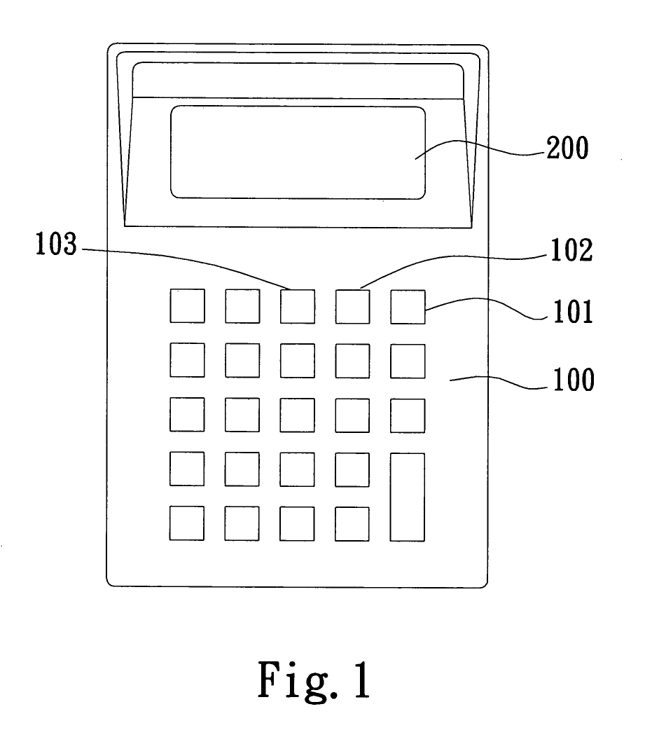

FIG. 1 shows an embodiment of conventional calculator, it is described before and we do not repeat herewith.

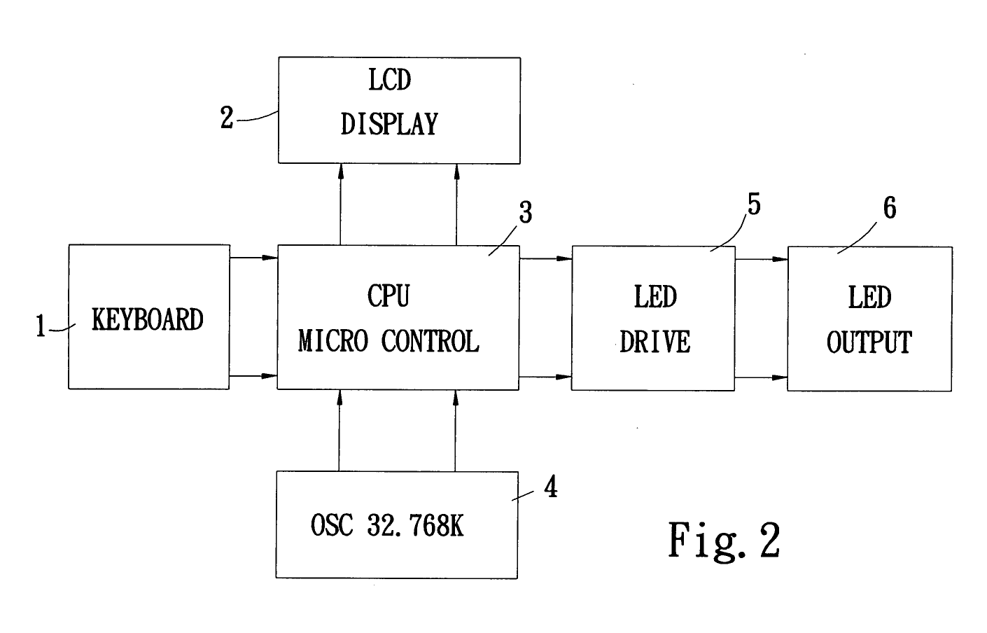

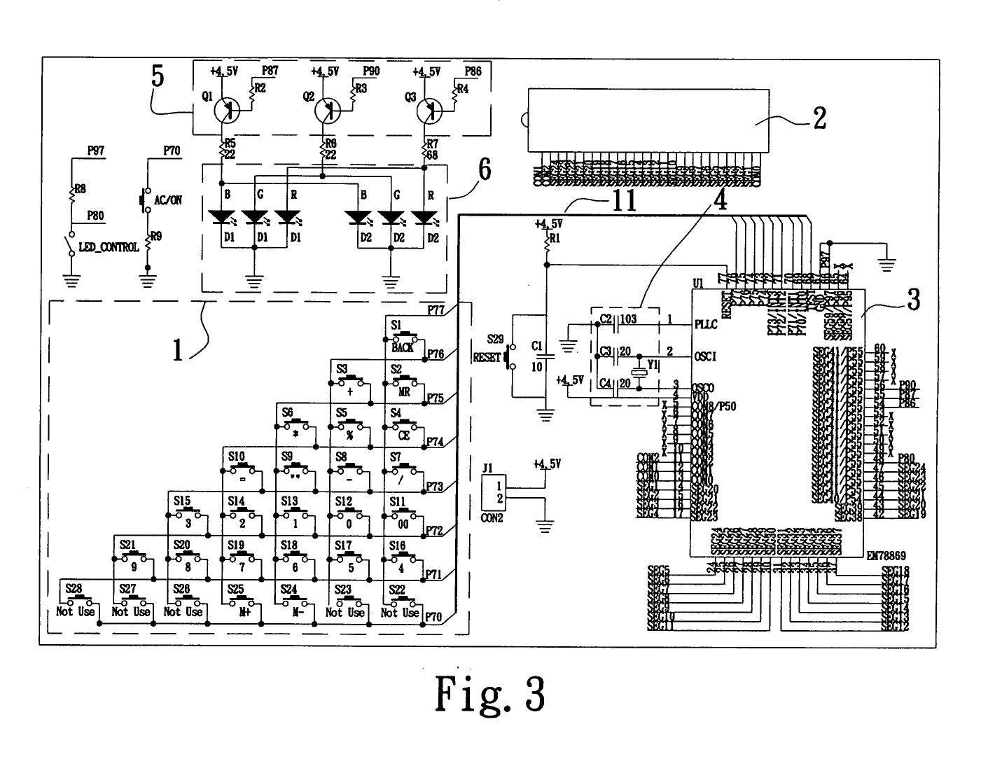

FIG. 2 is a block diagram of the operation circuit of present invention. It shows that calculator of present invention mainly comprises a keyboard, having a plurality of keys, a numbers displayer 2 for showing the result of calculation, a micro control central processing unit 3, an oscillating circuit 4, a LED driving circuit 5, and a set of light emitting diode (LED) 6.

Refer to FIG. 3, it shows an embodiment of the practical circuit of present invention. It is shown that the keyboard 1 of the calculator with a color changing display of present invention is formed by a plurality of pressing keys S1, S2, . . . including a reset switching key RESET, each of the pressing keys S1, S2 . . . has a special function itself. The pressing keys S1, S2, . . . , are divided into some groups and led to a bus line 11 having a plurality of terminals. Such that the pressing keys S1, S2, . . . RESET are connected to specified pins of the micro control CPU 3. The micro control CPU 3 is a storage memory with operation ability. It includes a number of pins and then, in addition to said pressing keys S1, S2, . . . RESET, it is also connected with said numbers displayer 2 formed by liquid crystal display, said light emitting driving circuit 5 and oscillating circuit 4. The numbers displayer 2 is a liquid crystal display (LCD), it contains a plurality of connecting pins COM1, COM2, . . . SEG1, COM0, to enable the numbers displayer 2 to be connected with the micro control CPU, and then, receive the signals transmitted from micro control CPU 3. The oscillating circuit 4 is constructed by an oscillator Y1 and a group of capacitors C3, C4 connected in parallel. Such that the clock pulse generated by the oscillator Y1 would be input into the micro control CPU after a control key is pressed, so as to keep the micro control operate normally. The light emitting diode (LED) 6 is preferably to be a plurality of light emitting diode bubbles D1, D2 which can respectively emit blue light, green light and red light. The LED driving circuit 5 is constructed mainly by a blue light driving transistor Q1, green light driving transistor Q2 and a red light driving transistor Q3. Each of collectors of said driving transistors Q1, Q2 and Q3 is respectively connected with blue light unit, green light unit and red light unit of the LED bubbles D1, D2. The emitters of said driving transistors Q1, Q2 and Q3 are connected to power supply, while the bases of said driving transistors Q1, Q2 and Q3 are respectively connected with the specified pins P86, P87, and P90 of said micro control CPU3. The operations of LED driving circuit 5 and light emitting diode 6 are controlled by a light emitting diode control switch LED CONTROL, while switch AC/ON controls the on-off of calculator. And the light colors of LED are changed by the technique of Pulse Width Modulation (PWM). That is, the waveforms of colors are adjusted by the speed of frequencies.

Please refer to FIG. 2 and FIG. 3 again, after batteries are installed into the housing, put the light emitting diode control switch LED CONTROL at “on” position, press AC/ON switching key of calculator, then LCD displays number “0”, and the light emitting diodes also display colors of light that changes randomly or fixed colors when any key is pressed on the calculator. If no key is pressed, the light emitting diodes then turned off after 30 seconds, and the power supply turns off automatically in one minute. When any key is pressed, colors of light that changes randomly are output. If the equal(=) key is pressed, a definite color of the LED is lightening, and five seconds later, the LED is color changingly displaying for forty to forty-five seconds, forty-five seconds later, the LED is turned off, while one minute later, the power supply of calculator is turned off. If the control switch of light emitting diode LED CONTROL is put in “off” position, there is no output of light, the calculator can only show the function of calculation and automatically turns off LCD in one minute.

According to the statement shown above, it is very clear to know that the calculator of present invention contains functions that never have been showed before, it is very obvious that the present invention contains approvable conditions of patent.

Although the invention has been described in terms of the presently preferred embodiments, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A calculator with a color changing display, comprising mainly:
a keyboard having a plurality of keys,
a numbers displayer for showing the result of calculation, and
a micro control central processing unit;
characterized in that: said micro control central processing unit further connects to an oscillating circuit and a driving circuit of light emitting diode, such that the calculator would display different colors of light in operation.

2. A calculator with a color changing display as claimed in claim 1, wherein said micro control central processing unit is a storage memory with operation ability.

3. A calculator with a color changing display as claimed in claim 1, wherein said keys comprise a reset key, a power switch, a switch for controlling on/off of light emitting diode and a plurality of keys with specified functions; said functional keys are divided into a plurality of groups and are led to a bus line, so as to connect with the micro control CPU.

4. A calculator with a color changing display as claimed in claim 1, wherein the numbers displayer is a liquid crystal display.

5. A calculator with a color changing display as claimed in claim 1, wherein said oscillating circuit comprises an oscillator and a plurality of capacitors connected in parallel, the output of oscillating circuit is also connected to micro control CPU.

6. A calculator with a color changing display as claimed in claim 1, wherein the light emitting diode comprises a plurality of light emitting diode bubbles of blue light, green light and red light; the LED driving circuit is constructed mainly by driving transistors of different light emitting diodes.
